(19) United States
(12) Patent Application Publication
(10) Pub. No.: US 2015/0083404 A1
(43) Pub. Date: Mar. 26, 2015

(54) DETERMINING PROPPANT AND FLUID DISTRIBUTION

(71) Applicant: SCHLUMBERGER TECHNOLOGY CORPORATION, Sugar Land, TX (US)

(72) Inventors: Michael Wilt, Walnut Creek, CA (US); Nestor Cuevas, Milano (IT); Lindsey Heagy, Vancouver (CA)

(21) Appl. No.: 14/494,313

(22) Filed: Sep. 23, 2014

Related U.S. Application Data
(60) Provisional application No. 61/881,277, filed on Sep. 23, 2013.

(51) Int. Cl. G01V 3/30; E21B 49/00

(52) U.S. Cl. CPC G01V 3/30; E21B 49/003
USPC 166/250.1; 703/10

(57) ABSTRACT

A method may include modeling a bulk electromagnetic (EM) characteristic of a composite material including a fracturing fluid, a proppant, and a sensing additive. The method may further include generating a modeled propped fracture pattern for a subterranean formation having the composite material injected therein, and generating a three dimensional (3D) arrangement of cells based upon the bulk EM characteristic and the modeled propped fracture pattern using an effective medium theory (EMT) model, with each cell having a modeled localized EM characteristic associated therewith. The method may also include injecting the composite material into the subterranean formation to cause an actual propped fracture pattern, collecting EM data based upon the sensing additive within the actual propped fracture pattern, and determining a respective actual EM characteristic for each cell based upon the modeled localized EM characteristics and the collected EM data.

### CROSS REFERENCE TO RELATED APPLICATION

This application claims benefit to U.S. Provisional Application No. 61/881,277 filed on Sep. 23, 2013, the entire contents of which is hereby incorporated by reference herein.

### BACKGROUND

Hydraulic fracturing, also known as “fracking,” is a technique used to create pathways for hydrocarbon resources, such as oil or natural gas, to flow in a subterranean rock formation. Before the fracking process, a wellbore is drilled through the top surface layers down to the rock formation where the hydrocarbon resource is located. A hydraulic fluid is then introduced into the wellbore and pressurized to create cracks or fractures through the rock formation, through which the hydrocarbon resource may be extracted through the wellbore.

To maintain a desired fracture width and help keep the fractures open, a proppant may be injected into the fractures. More particularly, materials such as grains of sand, ceramics, or other particulates are used as proppants to help prevent the fractures from closing when the injection is stopped and the pressure of the fluid is reduced. Different types of proppants may be selected for different depths, since at deeper depths the pressure and stresses are higher. The propped fractures are sufficiently permeable to allow the flow of the hydrocarbon resource to the wellbore, as well as other fluids that may be introduced into the wellbore during the drilling or fracturing process.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

A method may include modeling a bulk electromagnetic (EM) characteristic of a composite material comprising a fracturing fluid, a proppant, and a sensing additive. The method may further include generating a modeled propped fracture pattern for a subterranean formation having the composite material injected therein, and generating a three dimensional (3D) arrangement of cells based upon the bulk EM characteristic and the modeled propped fracture pattern using an effective medium theory (EMT) model, with each cell having a modeled localized EM characteristic associated therewith. The method may also include injecting the composite material into the subterranean formation to cause an actual propped fracture pattern, collecting EM data based upon the sensing additive within the actual propped fracture pattern, and determining a respective actual EM characteristic for each cell based upon the modeled localized EM characteristics and the collected EM data.

A related computing device may include a memory and a processor cooperating therewith to model a bulk EM characteristic of a composite material comprising a fracturing fluid, a proppant, and a sensing additive. The processor may also generate a modeled propped fracture pattern for a subterranean formation having the composite material injected therein, and generate a 3D arrangement of cells based upon the bulk EM characteristic and the modeled propped fracture pattern using an EMT model, with each cell having a modeled localized EM characteristic associated therewith. For an actual fracture pattern caused by injection of the composite material into the subterranean formation, the processor may determine a respective actual EM characteristic for each cell based upon the modeled localized EM characteristics and collected EM data, where the EM data is collected based upon the sensing additive within the actual propped fracture pattern.

A non-transitory computer-readable medium may have computer-executable instructions for causing a computer to at least model a bulk EM characteristic of a composite material comprising a fracturing fluid, a proppant, and a sensing additive; generate a modeled propped fracture pattern for a subterranean formation having the composite material injected therein; and generate a 3D arrangement of cells based upon the bulk EM characteristic and the modeled propped fracture pattern using an EMT model, with each cell having a modeled localized EM characteristic associated therewith. For an actual fracture pattern caused by injection of the composite material into the subterranean formation, a respective actual EM characteristic for each cell may be determined based upon the modeled localized EM characteristics and collected EM data, where the EM data is collected based upon the sensing additive within the actual propped fracture pattern.

### BRIEF DESCRIPTION OF THE DRAWINGS

FIG. 1 is a schematic block diagram of an example embodiment of a system for mapping induced fracture patterns in a subterranean formation.

FIG. 2 is a schematic block diagram of an example embodiment of the mapping device used in the system of FIG. 1.

FIG. 3 is an enlarged view of an example imaging or sensing additive to be included in a proppant mixture for use with the system of FIG. 1.

FIG. 4 is a flow diagram illustrating various fracture pattern mapping method aspects.

### DETAILED DESCRIPTION

The present description is made with reference to the accompanying drawings, in which example embodiments are shown. However, many different embodiments may be used, and thus the description should not be construed as limited to the embodiments set forth herein. Rather, these embodiments are provided so that this disclosure will be thorough and complete. Like numbers refer to like elements throughout.

Generally speaking, this disclosure provides a method for mapping the propped region of an induced fracture using EM imaging techniques. To generate a detectable EM response, the physical properties of the target should be different from the host. This may be accomplished by including electrically conductive, dielectric, or magnetic particles in the proppant, using a conductive fluid, or some combination thereof. This physical property contrast provides the geophysical target it is desired to characterize.

To model the EM response of a “doped” fracture, the effective electric, dielectric, and/or magnetic properties of the proppant and fluid mixture may first be characterized at various relative concentrations. For this, an effective medium theory (EMT) model may be used to assign an effective electrical conductivity, dielectric permittivity, or magnetic permeability to the proppant-fluid mixture based on the properties of both the particles and fluid, and their relative concentrations.

Then, a fracture modeling device (e.g., a computer and non-transitory computer readable medium) may be used to estimate a fracture distribution as well as the proppant and fluid distributions within that fracture. EMT is used to convert the fracture model to an EM-equivalent 3D prismatic, anisotropic electrical conductivity or magnetic permeability model, which may be used in a 3D EM forward modeling code. With the capability to model EM surveys for various source-receiver configurations and a given fracture distribution, a sensitivity study may then be used to design a field survey or model for a likely fracture distribution.

Once the field data has been collected, a 3D inversion may be used to recover a 3D anisotropic electrical conductivity, magnetic permeability, or electric permittivity model consistent with the field data, and optionally other available data sets or prior geological knowledge. The recovered model may be used to obtain information about the fracture, including the proppant distribution and primary orientation of the fracture. It may also be used to determine the subset of simulated fracture models that have proppant and fluid distributions consistent with the collected data, as will be discussed further below.

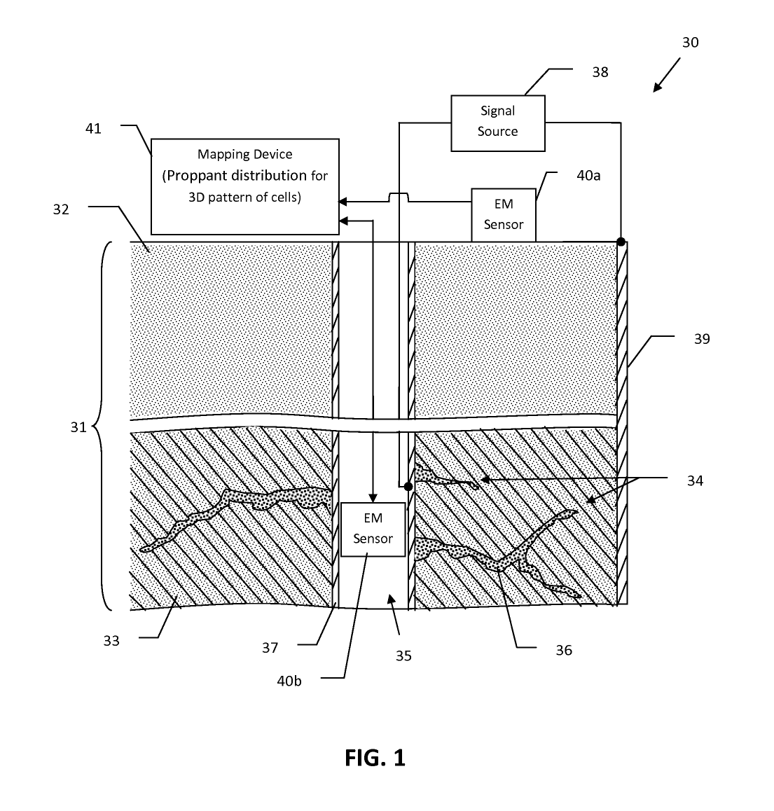

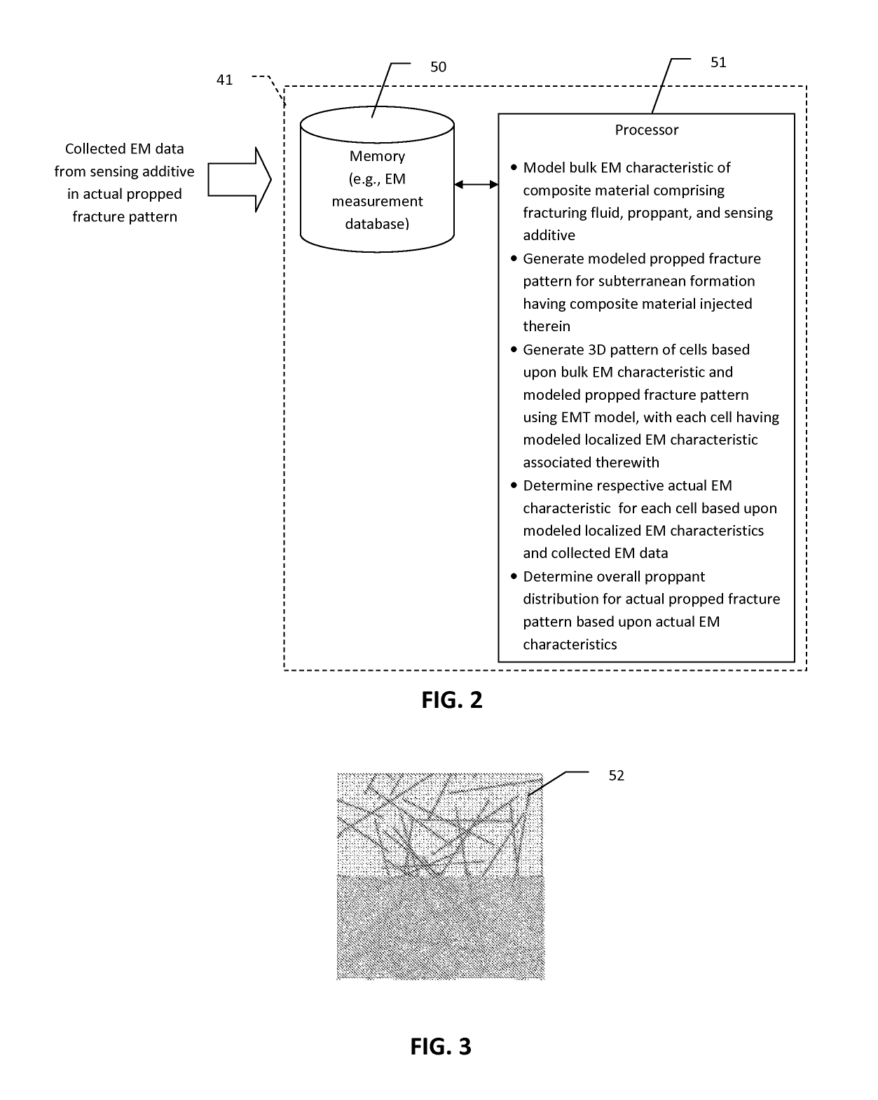

Referring now to FIGS. 1 and 2, a system 30 for imaging an induced fracture pattern in a subterranean formation 31 and related method aspects are first described. A wellbore 35 extends into the subterranean formation 31, which illustratively includes one or more upper layers 32 (e.g., topsoil, overlying rock formations, etc.) and a reservoir layer(s) 33 (e.g., a rock formation such as a shale, sandstone or limestone, etc.) where a hydrocarbon resource is located.

By way of background, induced fractures 34 are being used for developing oil and gas fields in the US and abroad. These fractures 34 provide pathways for fluids (e.g., oil, natural gas, etc.) to flow from the reservoir layers 33 into a wellbore 35 that is drilled into the subterranean formation 31. The fractures 34 enhance fluid flow in tight, low permeability formations. However, the geometry and characteristics of induced fractures 34 are not always well understood. Of interest to engineers and field operators is the determination of what part of the fractured volume has been forced to remain open by an injected proppant 36 within the fractures 34. A “propped” fracture 34 is considered to be a primary contributing factor to the portion of the fractured volume that is connecting the reservoir and the wellbore 35.

Generally speaking, the apparatus 30 and related method aspects described herein allow for improving the detectability of a propped segment of induced fractures 34 using co-injected contrast or imaging agents or additives, and EM methods to image these fractures. The approach involves injecting conductive, dielectric and/or magnetic contrast agents (also referred to as a sensing additive herein) along with proppants such as sand and/or ceramic materials. These contrast agents may be introduced as a mixture with regular proppants, the proppants may be modified to incorporate contrast agents, or a mixture of both may be used. The sensing additive may have similar sizes as the proppant particles so that there is relatively little loss of the proppant/contrast material into the formation. Subsequently, the location and distribution of the sensing additive may be illuminated and interrogated by single well, as described further below, or multi-well EM approaches, as discussed further in co-pending application Ser. No. 13/923,311 to Wilt et al., which is assigned to the present Assignee and is hereby incorporated herein in its entirety by reference.

The borehole 35 is formed (e.g., drilled) in the subterranean formation 31, and in some implementations at least part of the borehole is lined with an electrically conductive casing 37. The conductive casing 37 may serve several purposes, such as support during drilling, allowing flowback returns during drilling and cementing of the surface casing, and to help prevent collapse of loose soil near the surface, for example. Typical sizes for a conductive casing may be from about 18 to 30 inches, although other sizes may be used as well. By way of example, the conductive casing 37 may comprise steel, etc.

After a fracturing fluid is injected into the borehole 35 to induce the fractures 34, a proppant is injected into the borehole to form a propped fracture pattern, at Block 34. The fracturing fluid and proppant may be injected through holes in the casing 37, for example. More particularly, the casing 37 allows the interval in the borehole 35 to be pressure-isolated, and perforations in the casing in the interval of interest allow the fracking fluid and proppant to be introduced at that location. As noted above, the proppant (and/or the fracturing fluid) includes a sensing additive. As a result, the electrically conductive casing 37 may be driven by a signal source 38 so that the sensing additive generates an electromagnetic (EM) field. That is, the casing 37 essentially provides an antenna to illuminate the sensing additive within the fractures 34. The EM field generated by the sensing additive may be considered as a total EM field resulting from the primary field from the signal source 38 as well as the secondary field from the target (i.e., sensing additive).

In the illustrated example, the signal source 38 is coupled to the casing 37 within the wellbore 35 adjacent to the area where the fractures 34 are located. The signal source 38 is also coupled to an electrode 39, which is positioned in the subterranean formation 31 and spaced apart from the borehole 35. However, other suitable electrode configurations or placements may be used when driving the casing 37. It should be noted, however, that the casing 37 need not be used in all embodiments, and that the sensing additive may instead be energized or driven directly from the signal source 38, as will be appreciated by those skilled in the art.

In the example illustrated in FIG. 1, EM sensors 40a, 40b are positioned in the borehole 35 adjacent the fractures 34 to be imaged, and remote from the borehole (e.g., at the surface), respectively, although one or the other may be used in some embodiments. The EM sensors 40a, 40b are configured to sense an EM field from the sensing additive when driven by the signal source 38 via the casing 37 (or otherwise). Example measuring units which may be configured to provide EM sensing are described in U.S. Pat. No. 4,796,186 to Kaufman and U.S. Pat. No. 4,820,989 to Vail, III, which are hereby incorporated herein in their entireties by reference.

The system 30 further illustratively includes a mapping device 41 (e.g., a computing device or computer) coupled to the EM sensor 40. As shown in FIG. 2, the mapping device 41 illustratively includes a memory 50 and processor 51 coupled with the memory. EM field data from the EM sensor 40a and/or 40b may be collected and stored in a database in the memory 50. The various operations performed by the processor 51 described herein may be implemented using a non-transitory computer readable medium having appropriate computer-executable instructions, for example. It should be noted that some or all of the mapping device 41 components may be located remotely from the well site. That is, the EM data may be collected at the well site for mapping using a mapping device(s) 41 located offsite.

With respect to the sensing additive, a relatively small volume fraction of a highly conductive material in the fracture fluid and/or proppant 36 can make the effective conductivity of the fractured regions 34 filled by this proppant relatively high. Generally speaking, the electrical properties of the proppant mixtures are determined by the electrical conductivity, concentration, shape and distribution of constituents. There is a percolation type behavior when highly conducting material is distributed in a relatively poorly conducting host. That is, the overall conductivity remains low until the highly conducting phase forms a well-connected “percolating” path for conduction.

In the case of the proppant-fluid mixture contained by the fractured region 34, the “host” may be the fracture fluid and inert portion part of the proppant. The highly conducting part may be metallic particles such as aluminum or graphite beads, a conducting polymer, or a conductive material coating on sand/ceramic that can be mixed with the sand. The percolation threshold (f_{c}) volume fraction depends on the aspect ratio. For an example spherical grain configuration, theoretical models give f_{c} to be about 0.28, that is, a relatively large volume fraction of conducting phase is needed, although it should be noted that f_{c} may vary with different distributions of grain sizes (i.e., it may be different if spheres are the same size vs. a range of sizes), or with different types of sphere packing geometries. However, this percolating volume fraction may be reduced by using different geometries, such as an elongate or needle-like conductive phase particles 52, as shown in FIG. 3. That is, a relatively small volume fraction of needle-shaped conductive particles 52 may form a spanning or a percolating path through the propped fractures 34. By way of example, such non-spherical sensing co-agents may be included in the proppant mix to enhance the proppant conductivity or polarization at modest concentration levels of less than 15% by volume, and more particularly about 10-15%. Stated alternatively, a proppant to sensing additive volume ratio may be greater than about 7 to 1. Example sensing agents may include aluminum, pyrite, magnetite, or graphite, and may be chosen based upon compatibility with chemistry of the fracture fluids. As noted above, inert proppants (e.g., sand, ceramic, etc.) may be coated with conductive or magnetic agents using doped polymers or resins.

By way of example, proppant sensing additives may be illuminated by various electromagnetic mechanisms. First, if the sensing additive changes the magnetic susceptibility of the propped zone, it can be illuminated with a low frequency magnetic signal (e.g., 20 Hz or less) that couples into the proppant through an enhancement of the magnetic field. Another approach is that electrically conductive sensing additives may be illuminated using a relatively low frequency electrical signal (e.g., 100 Hz or less), or a higher frequency electrical or magnetic source (e.g., 1000 Hz or less). At low frequency, the electrical signals are directly affected, via Ohm's law, due to the change in electrical conductivity of the propped fracture 34. At higher frequencies, the electrical or magnetic signals couple electromagnetically into the proppant 36, causing secondary currents to flow and these currents, in turn, produce secondary EM fields. This affect is analogous to a transformer coupling.

Another approach is that conductive sensing additives may also be detected from their polarization effect. More particularly, if dielectric particles are included, then a low frequency EM field will polarize the isolated dielectric regions (e.g., similar to magnetics).

Contrast sensing additives which may be used to enhance the magnetic field include magnetite, illmenite or particles of iron. Conductivity enhancements may be affected by various metallic conductors including pyrite, aluminum, graphite, or a stainless steel coating, etc. Polarizability may be enhanced by dielectric particles.

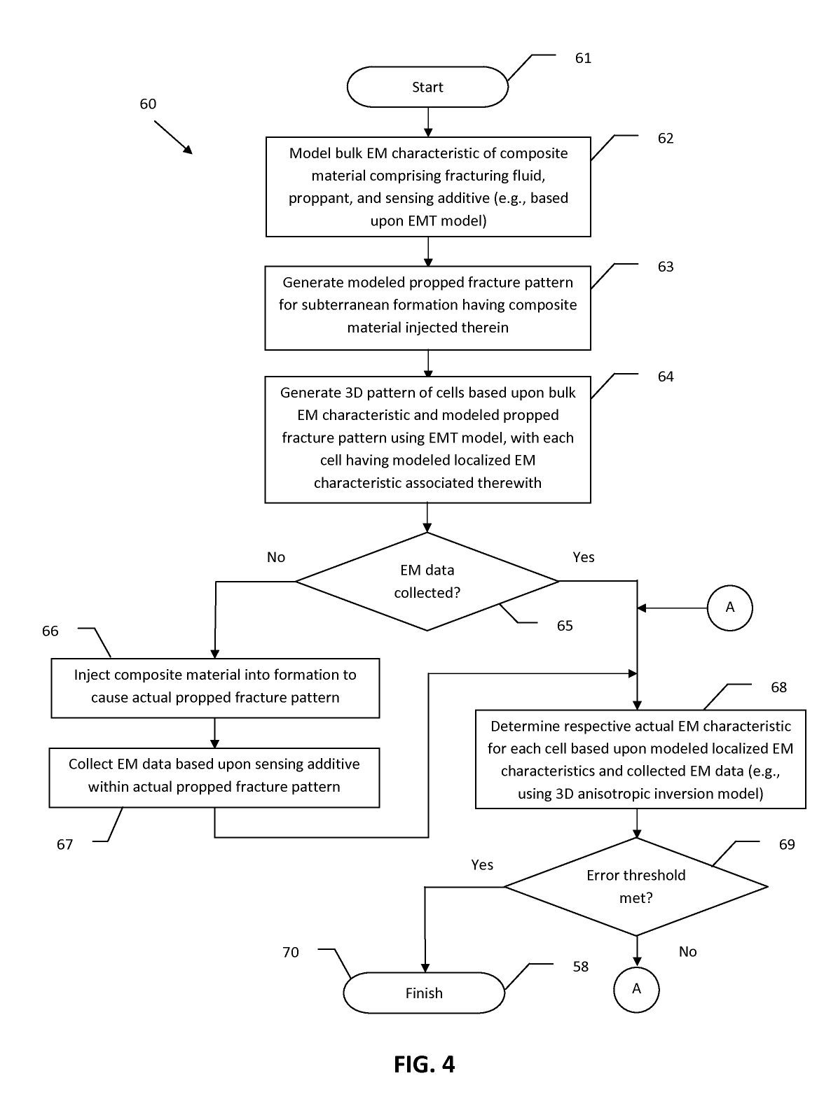

Turning now to FIG. 4, an example approach for mapping the propped fracture pattern is now described with reference to the flow diagram 60. Generally speaking, this approach uses electrically conductive, dielectric, or magnetic proppant particles (i.e., a sensing additive) to create a physical property contrast between the propped region of the fracture and the host rock. Beginning at Block 61, a bulk EM characteristic of a composite material including the fracturing fluid, proppant, and sensing additive may be modeled, at Block 62. For example, EMT may be used to model the bulk-scale EM properties of the propped region of a “doped” hydraulic fracture.

More particularly, to generate a measurable EM response, the hydraulic fracture should have physical properties that are distinct from the host rock. For this approach, electrical conductivity, dielectric permittivity, and magnetic permeability are considered as distinguishing properties of interest. Since the geophysical target of interest is the propped region of the fracture, the sensing additive provides a conduit through which we can alter the properties of the propped region of the fracture. As noted above, the sensing additive may include conductive particles or fibers, such as carbon fiber, in the proppant, or may be a conductive (or magnetic) coating on the proppant, such as graphite. The fluid may also be made conductive by including salts. Another approach is to create a magnetic target by including magnetic particles, such as magnetite. The relative merits of choosing either a conductive, dielectric, or magnetic proppant depends on pumping parameters, such as density and crush strength, as well as geophysical survey constraints such as source and receiver types and configuration, as will be appreciated by those skilled in the art.

The fluid and proppant will be distributed within the fracture in varying concentrations, so to model the EM response of the fracture it is helpful to understand the EM properties of the mixture as a function of the fluid and proppant properties. For this, EMT may be used, which approximates the EM response of a composite material with physical properties that vary on a microscopic scale, by a homogeneous material with properties that vary on a meso- or macroscopic scale. See, e.g., Torquato, S., 2002, Random heterogeneous materials: Microstructure and macroscopic properties: Springer, which is hereby incorporated herein in its entirety by reference. Various effective medium approximations may be used, such as the Maxwell Approximation (Maxwell, 1873), Self Consistent (SC) method (see, e.g., Bruggeman, D., 1935, The calculation of various physical constants of heterogeneous substances. i. the dielectric constants and conductivities of mixtures composed of isotropic substances: Ann. Phys, 24, 636-679; Landauer, R., 1952, The electrical resistance of binary metallic mixtures: Journal of applied physics, 23, 779-784; and Landauer, R., 1978, Electrical conductivity in inhomogeneous media, in Electrical, Transport and Optical Properties of Inhomogeneous Media: AIP, New York, 2-43, all of which are hereby incorporate herein in their entireties by reference), or the Differential Effective Medium (DEM) method (Bruggeman, 1935). By invoking one of these methods, a conductivity, dielectric permittivity, or magnetic permeability model of the fluid-proppant mixture may be approximated by an equivalent effective conductivity, permittivity or permeability model for varying concentrations of fluid and proppant, as will be appreciated by those skilled in the art. Since all of these methods are based on the approach for a single inclusion in a static field, they may be applied to electric conductivity, dielectric permittivity or magnetic permeability in a similar manner, as will also be appreciated by those skilled in the art. In the case of a well-mixed proppant-fluid composite, with spherical proppant particles, the resulting effective EM properties will be isotropic.

The method may further include generating a modeled propped fracture pattern for a subterranean formation having the composite material injected therein, at Block 63. That is, the effective physical properties of the hydraulic fracture pattern may be determined in this step. More particularly, with the properties of the proppant and fluid specified, the distribution of the proppant and fluid within the reservoir may be determined. These distributions may depend on several factors including pumping parameters, such as pressure, and reservoir parameters, such as in-situ stress. To model the expected fracture, fluid and proppant distribution, fracture-modeling software, such as the Mangrove Reservoir-Centric Stimulation Design Software from Schlumberger Limited, may be used to predict the fracture geometry as well as proppant and fluid distributions based on the pumping and reservoir parameters. It should be noted that the steps described at Blocks 62 and 63 may be performed in parallel, or their order may be reversed (i.e., generate the fracture model with proppant distribution, then determine effective properties of composite), in some embodiments, if desired.

The method further illustratively includes generating a three dimensional (3D) arrangement of cells based upon the bulk EM characteristic and the modeled propped fracture pattern using an EMT model, with each cell having a modeled localized EM characteristic associated therewith or assigned thereto, at Block 64. More particularly, to model an EM survey, the above-noted fracture model may be turned into a physical property model that can be incorporated into a 3D EM forward modeling code. This may include discretizing the region to be modeled into a mesh of prismatic cells, and assigning these cells specific physical properties. A fracture presents a challenge to this process, as it is very thin but may extend tens or hundreds of meters both laterally and vertically. While using a mesh fine enough to capture the thickness of a fracture is in theory possible, this may be computationally unreasonable in many cases. On the other hand, using a mesh on the order of one to tens of meters, while less computationally intensive, may miss the fracture to be modeled.

As such, in the present approach, physical properties are associated to each cell in a coarse mesh so that they approximate the physical response of the fracture segment included within the cell. To do this, EMT may again be used to model the effective EM properties of a fractured rock volume. More particularly, the EMT calculation may be performed for each cell in the domain in a two-stage process. First, an effective conductivity of the proppant/fluid mixture may be determined based on their relative concentrations, as described above. Next, the effective conductivity (or dielectric permittivity or magnetic permeability) of each of the cells in the mesh containing both host rock and fracture may be approximated. For this step, one suitable approach which may be used is set forth in Berryman, J. G., and G. M. Hoversten, 2013, Modelling electrical conductivity for earth media with macroscopic fluid-filled fractures: Geophysical Prospecting, 471-493, which is hereby incorporated herein in its entirety. For this approach, it will be assumed that a fracture is composed of spheroidal or ellipsoidal cracks which contain the proppant fluid mixture. With this assumption, we are then able to apply the above-noted SC approximations for ellipsoidal inclusions set forth by Berryman and Hoversten. See also Shafiro, B., and M. Kachanov, 2000, Anisotropic effective conductivity of materials with nonrandomly oriented inclusions of diverse ellipsoidal shapes: Journal of applied physics, 87, 8561-8569, which is also incorporated herein in its entirety by reference.

The SC approximation is well suited for fractal-like composites that are self-similar on many scales. See, e.g., Milton, G., 1985, The coherent potential approximation is a realizable effective medium scheme: Communications in mathematical physics, 99, 463-500, which is hereby incorporated herein in its entirety by reference. By using this approach, it is assumed that an induced fracture is not just a sheet, but it includes many small cracks that are preferentially aligned parallel to the fracture. The SC calculation may be completed cell-by-cell until each cell in the mesh has been assigned a respective effective (i.e., localized) conductivity. Since the cracks that make up the fracture are aligned preferentially with the fracture plane, the conductivity may be anisotropic, meaning that it is described by a 3×3 tensor. If the fracture plane aligns with the principal axes of the mesh, the effective conductivity will be a diagonal tensor. Otherwise, it may be a full tensor having 6 independent elements (i.e., it is symmetric).

Furthermore, other EMT methods such as the above-noted Maxwell Approximation or DEM approximation may also be used in this calculation. The Maxwell approximation assumes that the inclusions do not interact, but at high concentrations, or if the inclusions are in close proximity, this approximation may be less appropriate. The DEM approximation assumes that the background phase remains connected for all volume fractions of inclusions. See, e.g., Yonezawa, F., and M. H. Cohen, 1983, Granular effective medium approximation: Journal of applied physics, 54, 2895-2899, which is hereby incorporate herein in its entirety by reference. Yet, in the case of a fracture, it may be likely that when looking at a cell within the mesh that the fracture breaks up the background so it is no longer connected. Thus, this approach may be suited for composites such as particles in a suspension.

If not already performed (Block 65), the composite material may be injected into the subterranean formation 31 to cause the actual propped fracture pattern 34, at Block 66, and EM data may be collected based upon the sensing additive within the actual propped fracture pattern (Block 67), as discussed above. It should be noted that the above-described modeling flow operations (i.e., Blocks 61-64) may be performed before fracking/EM measurements are performed, as set forth above, or after. The steps illustrated at Blocks 65-70 may conceptually be considered as the field/mapping portion of the workflow.

The EM response for various source-receiver configurations may be modeled using an existing 3D EM forward modeling code (e.g., Randy Mackie's finite-difference 3D codes, etc.). This may be used to do sensitivity studies on the conductivity model and determine a survey design capable of detecting the anomaly created by the induced fracture. Various steps may be used in the EM survey process. First, the target (i.e., sensitivity additive) is excited, meaning the transmitter is coupled to the fractured volume. To improve this coupling, different transmitter types may be appropriate for different geological formations and proppant mixtures, as well as fracture geometries and infrastructure constraints (e.g., if the wells are cased or not). Generally speaking, the transmitter selection may be based upon factors such as whether an electric or magnetic source is more appropriate, the type of waveform it transmits (e.g., static, sinusoidal, or a step-off function), orientation, and where it is located. With respect to measuring the secondary response generated by the fracture, this may include coupling between the target and the receivers to measure the electric and/or magnetic fields based upon the various components (horizontal, vertical or 3-component) and the receiver position used, as will be appreciated by those skilled in the art.

The method further illustratively includes determining a respective actual EM characteristic for each cell of the actual propped fracture pattern 34 based upon the modeled localized EM characteristics and the collected EM data, at Block 68, from which an overall proppant distribution for the actual propped fracture pattern may be determined More particularly, based upon the collected data for the actual propped fracture pattern 34, information about the distribution of proppant within the 3D arrangement of cells, and thus a geometry of the propped fracture as a whole, may be inferred or estimated. For instance, a volume of proppant within respective cells, and optionally a preferred direction, may be estimated, as will be appreciated by those skilled in the art.

By way of example, once the EM data has been collected, a 3D anisotropic inversion may be used to determine a conductivity model that fits the data, subject to constraints. These constraints may include prior geological knowledge or other data sets, such as well logs, seismic, or microseismic data sets. They may also assume properties of the model, e.g., smoothness, etc. A conductivity anomaly is an indicator of the distribution of the proppant within the reservoir, and may therefore be used as a mapping tool to delineate the propped region of the reservoir. Also, if the anisotropic nature of the conductive anomaly created by the propped region of the fracture is recovered, this provides information on the orientation of the fracture, as the conductivity is expected to be greatest parallel to the plane of the fracture, and smallest perpendicular to the plane of the fracture.

These models may also be used to determine the subset of fracture realizations produced by a fracture modeling system that are consistent with the measured data. This may involve using the recovered conductivity model as a constraint for the fracture generating code, e.g., by putting bounds on the allowable proppant volume within a given region of the reservoir. Another approach is that the data may be used in an iterative forward modeling study for the fracture distribution. That is, the steps described above with respect to Blocks 63-64 and forward modeling may be iteratively performed to achieve the results provided at Block 68 until the modeled localized EM characteristics are within an error threshold of the collected EM data, at Block 69, which illustratively concludes the method of FIG. 4 (Block 70). That is, above-noted parameters used to compute the fracture realizations may be adjusted until the resulting conductivity model generates an EM response that agrees with the observed data, as will be appreciated by those skilled in the art.

Many modifications and other embodiments will come to the mind of one skilled in the art having the benefit of the teachings presented in the foregoing descriptions and the associated drawings. Therefore, it is understood that various modifications and embodiments are intended to be included within the scope of the appended claims.

That which is claimed is:

1. A method comprising:
modeling a bulk electromagnetic (EM) characteristic of a composite material comprising a fracturing fluid, a proppant, and a sensing additive;
generating a modeled propped fracture pattern for a subterranean formation having the composite material injected therein;
generating a three dimensional (3D) arrangement of cells based upon the bulk EM characteristic and the modeled propped fracture pattern using an effective medium theory (EMT) model, and with each cell having a modeled localized EM characteristic associated therewith;
injecting the composite material into the subterranean formation to cause an actual propped fracture pattern;
collecting EM data based upon the sensing additive within the actual propped fracture pattern; and
determining a respective actual EM characteristic for each cell based upon the modeled localized EM characteristics and the collected EM data.

2. The method of claim 1 wherein modeling the bulk EM characteristic of the composite material comprises modeling the bulk EM characteristic based upon the EMT model.

3. The method of claim 1 further comprising determining an overall proppant distribution for the actual fracture pattern based upon the actual EM characteristics for the cells.

4. The method of claim 1 wherein determining the respective actual EM characteristic for each cell comprises determining the respective actual EM characteristic for each cell based upon a 3D anisotropic inversion.

5. The method of claim 1 wherein determining the actual EM characteristics is iteratively performed until the modeled localized EM characteristics are within an error threshold of the actual EM characteristics.

6. The method of claim 1 wherein the subterranean formation has at least one borehole therein; and wherein collecting the EM data comprises collecting the EM data from within the at least one borehole.

7. The method of claim 1 wherein the subterranean formation has at least one borehole therein; and wherein collecting the EM data comprises collecting the EM data remote from the borehole.

8. The method of claim 1 wherein collecting the EM data comprises driving the sensing additive with a magnetic source and sensing a magnetic field from the sensing additive.

9. The method of claim 1 wherein collecting the EM data comprises driving the sensing additive with an electrical source and sensing an electrical field from the sensing additive.

10. The method of claim 1 wherein the sensing additive comprises at least one of electrically conductive particles, magnetic particles, and polarizable particles.

11. A computing device comprising:
a memory and a processor cooperating therewith to
model a bulk electromagnetic (EM) characteristic of a composite material comprising a fracturing fluid, a proppant, and a sensing additive,
generate a modeled propped fracture pattern for a subterranean formation having the composite material injected therein,
generate a three dimensional (3D) arrangement of cells based upon the bulk EM characteristic and the modeled propped fracture pattern using an effective medium theory (EMT) model, and with each cell having a modeled localized EM characteristic associated therewith, and
for an actual fracture pattern caused by injection of the composite material into the subterranean formation, determine a respective actual EM characteristic for each cell based upon the modeled localized EM characteristics and collected EM data, the EM data collected based upon the sensing additive within the actual propped fracture pattern.

12. The computing device of claim 11 wherein said processor models the bulk EM characteristic of the composite material based upon the EMT model.

13. The computing device of claim 11 wherein said processor is further configured to determine an overall proppant distribution for the actual fracture pattern based upon the actual EM characteristics for the cells.

14. The computing device of claim 11 wherein the respective actual EM characteristic for each cell is determined based upon a 3D anisotropic inversion.

15. The computing device of claim 10 wherein said processor iteratively determines the actual EM characteristics until the modeled localized EM characteristics are within an error threshold of the actual EM characteristics.

16. A non-transitory computer-readable medium having computer-executable instructions for causing a computer to at least:
model a bulk electromagnetic (EM) characteristic of a composite material comprising a fracturing fluid, a proppant, and a sensing additive;
generate a modeled propped fracture pattern for a subterranean formation having the composite material injected therein;
generate a three dimensional (3D) arrangement of cells based upon the bulk EM characteristic and the modeled propped fracture pattern using an effective medium theory (EMT) model, and with each cell having a modeled localized EM characteristic associated therewith; and
for an actual fracture pattern caused by injection of the composite material into the subterranean formation, determine a respective actual EM characteristic for each cell based upon the modeled localized EM characteristics and collected EM data, the EM data collected based upon the sensing additive within the actual propped fracture pattern.

17. The non-transitory computer-readable medium of claim 16 wherein the bulk EM characteristic of the composite material is modeled based upon the EMT model.

18. The non-transitory computer-readable medium of claim 16 further having computer-executable instructions for causing the computer to determine an overall proppant distribution for the actual fracture pattern based upon the actual EM characteristics for the cells.

19. The non-transitory computer-readable medium of claim 16 wherein the respective actual EM characteristics for each cell is determined based upon a 3D anisotropic inversion.

20. The non-transitory computer-readable medium of claim 16 wherein the actual EM characteristics are determined iteratively until the modeled localized EM characteristics are within an error threshold of the actual EM characteristics.
